(19) United States
(12) Patent Application Publication
(10) Pub. No.: US 2013/0066918 A1
(43) Pub. Date: Mar. 14, 2013

(54) SYSTEM AND METHOD FOR PROVIDING AN ELECTRONIC LIBRARY

(71) Applicants: Mahyar Nejat, La Jolla, CA (US); Klaus Hofrichter, San Diego, CA (US)

(72) Inventors: Mahyar Nejat, La Jolla, CA (US); Klaus Hofrichter, San Diego, CA (US)

(73) Assignee: Sony Corporation, Tokyo (JP)

(21) Appl. No.: 13/232,560

(22) Filed: Sep. 14, 2011

(51) Int. Cl. G06F 17/30

(52) U.S. Cl. 707/783; 707/E17.005

(57) ABSTRACT

System and methods are provided for an electronic library service. In one embodiment, a method includes receiving a request for content of the electronic library service, the request identifying an account number for the electronic library service and identification number of a device, and authenticating the request based on an account number for the electronic library service and identification number of a device. The method may further include determining that content associated with the request is available for access by the device based on one or more restriction limitations, and providing access to the content based on one or more restriction limitations, wherein content of the electronic library is accessible to a device associated with the account number for a limited period of time.

### FIELD

The present disclosure relates generally to computer systems and devices, and more particularly to a system and methods for providing an electronic library service.

### BACKGROUND

Conventional libraries typically provide a collection of books and other published material to allow account holders to borrow material or utilize the collection within the library. A significant amount of most library collections is in print form. As such, the conventional library requires a substantial outlay of space and storage capacity for a library collection. With the development of electronic devices, and in particular personal computing devices, there is a desire to provide library resources to users which allows for a reduction on the amount of print and paper products while still providing access to content of the library. Many library users appreciate the ability to access content in a library at little or no charge. Thus, there is additionally a desire to allow for content to be provided to users for free or at a reduced cost.

In additional to the limitations of conventional libraries, there also exists a desire to allow for content publishers to provide content to libraries without necessarily distributing content in paper form. Publishing content in paper and other media formats can require a significant expense, but may also be limited in the number of library outlets that may be reached. Similar difficulties may also be presented in distribution and management of other types of content to libraries.

Accordingly, there exists a desire to provide content of a library collection which overcomes one or more of the aforementioned drawbacks. Similarly, there exists a desire to reduce the amount of paper required for distribution of media and publications for library collections. Accordingly, there is a desire for a platform to allow access to a library collection electronically.

### BRIEF SUMMARY OF THE EMBODIMENTS

Disclosed and claimed herein are a system and methods for providing an electronic library service. In embodiment, a method includes receiving, by a server, a request for content of the electronic library service, the request identifying an account number for the electronic library service and identification number of a device, and authenticating the request, by the server, based on an account number for the electronic library service and identification number of a device. The method further includes determining, by the server, that content associated with the request is available for access by the device based on one or more restriction limitations, and providing access to the content based on said determining associated with the one or more restriction limitations, wherein the content of the electronic library is accessible to a device associated with the account number for a limited period of time. Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a system for providing an electronic library service according to one or more embodiments;

FIG. 2 depicts a process for providing an electronic library service according to one or more embodiments;

FIG. 3 depicts a simplified block diagram of a device according to one embodiment;

FIG. 4 depicts a process for interfacing with a device by a library server according to one or more embodiments;

FIG. 5 depicts a process for operation of an electronic library service application on a device; and

FIGS. 6A-6B depict graphical representations of an electronic library service application according to one or more embodiments.

### DETAILED DESCRIPTION OF THE EXEMPLARY EMBODIMENTS

### Overview and Terminology

One aspect of the disclosure relates to an electronic library service for providing content associated with an electronic library to electronic devices. In one embodiment, an electronic library service may relate to a network based service to provide content to one or more electronic devices. In one embodiment, a platform is provided for access to content of the electronic library service, such as electronic books, publications, applications, games, data services, and media. Content of the electronic library service may be accessed for a specified period of time by authorized electronic devices. In that fashion, content may be borrowed, or rented electronically. The use of electronic devices for the electronic library service may be beneficial as devices may be used to present multiple forms of content and may be reused by one or more users. Other benefits include the ability to track electronic devices, the ability to use one or more different types of applications on a device, a reduction in size and cost for maintaining a conventional library, simplified organization of library content, and a reduction of paper products. Thus, an electronic library service may overcome one or more drawbacks of conventional library systems. For example, an electronic library service may advantageously reduce the number of books in print form, and in some cases eliminate the need for publications in paper form, by providing access to electronic content for a limited period of time.

In one embodiment, a system is provided for an electronic library service. The system may include a library server configured to provide content to one or more electronic devices. The library server may be configured to provide content to electronic devices associated with a particular library, such as library or loaner devices. In certain embodiments, the library server may additionally allow personal devices to access content of an electronic library service. The system may be configured to provide access based on one or more of authentication of a user or device, one or more restrictions associated with content, one or more restrictions associated with the user, and the device requesting access to content. The system may be configured to manage distribution of content to a plurality of users and devices. According to another embodiment, the server may be configured to allow for one or more servers to allow for electronic content to be accessed. The system may additionally include an electronic content server configured to provide content to library servers and receive electronic content from content sources.

Another embodiment is directed to a method of providing an electronic library service. The method may be employed by applications on a server and one or more devices to allow for access of content associated with an electronic library service. The method may include authenticating a request for content and providing access to content based on one or more restrictions. The method may be employed by library applications configured to provide an electronic library service on a library device and/or a personal device. In certain embodiments, the electronic library service may provide access or rental to digital versions of texts. For example, digital texts associated with education (e.g., university, high school, technical training, professional training, etc.) may be provided by the library service for a period of time. As such, one benefit of the electronic library service may be that multiple texts may be placed on a single device. Providing multiple texts on a single device may be advantageous for users and facilitate transport due to the when placed on a lightweight device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a non-transitory medium, etc.

### Exemplary Embodiments

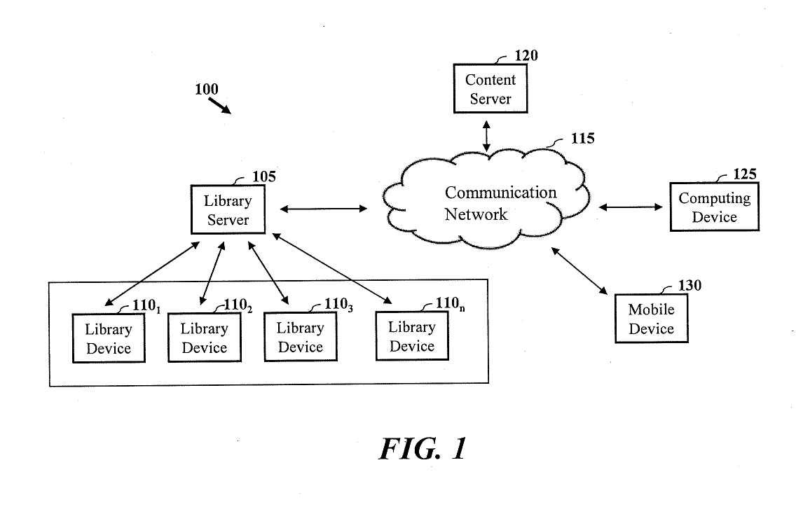

Referring now to the figures, FIG. 1 depicts a graphical representation of a system for providing an electronic library service according to one or more embodiments. As depicted in FIG. 1, system 100 includes library server 105, library devices 110₁₋ₙ, communication network 115, content server 120, computing device 125 and mobile device 130. In one embodiment, system 100 may allow for one or more devices to access content of an electronic library service from library server 105. Access may be based on one or more of authentication of a device, authentication of a user account with the library, and a restriction associated with the content. By imposing one or more restrictions on the content, content may be provided to the devices at a reduced price, or in some cases, free of charge. Similarly, restrictions imposed on content may allow for the electronic library service to limit distribution of content to a particular amount of users. One of the advantages of the electronic library service may be to reduce the amount of content required in print form. By replacing publications such as periodicals and books with electronic content, the amount of storage space required for a library may be reduced. Similarly, the impact of publishing content associated with printing may be reduced. Other benefits include the ability to reuse devices, track devices, and configure device operation to suit an electronic library service. Providing content in electronic form may additionally allow for research or browsing of the electronic library collection away from the library.

In one embodiment, library server 105 may be configured to authenticate requests based on the device making a request, such as one of library devices 110₁₋ₙ. Alternatively, or in combination, library server 105 may be configured to authenticate requests based on an account number associated with the request, such as a library account number. Based on the authentication, server 105 may provide an electronic library service that controls the distribution of content, and in some instances limits distribution of content based on one or more restrictions. Restrictions may be associated with content of the electronic library service and one or more of checking-out content, loaning content, providing temporary or periodic access to content, monitoring device use and tracking content distribution.

Library server 105 may be configured to provide an electronic library service for one or more library locations. Library server 105 may include a memory or interface with a storage device to provide content for the electronic library service. In one embodiment, content provided by the electronic library service may be one or more of electronic books, media files, applications, audio data, video data, electronic periodicals, reference material, and digital media in general. Server 105 may be configured to manage distribution of content to one or more devices based on an electronic library account or account number. In another embodiment, server 105 may be configured to provide an application or user interface for one or more devices. The application may be an electronic library service application including functions to provide browsing and researching of content of the electronic library, and providing a user interface. Server 105 may alternatively provide one or more applications to a device for a temporary period of time. By way of example, library devices 110₁₋ₙ may be configured to temporarily provide an application, such as a research application, word processing application, CAD application, gaming application, educational application or computer application in general.

Library devices 110₁₋ₙ may be computing devices, such as a personal computer, tablet computing devices, or handheld computing devices in general. In certain embodiments, library devices 110₁₋ₙ may be loaner devices assigned to a library account for a period of time. Library devices 110₁₋ₙ may allow for library users to access content electronically. In one embodiment, the library devices may be borrowed or rented from a library for specified period of time. Similar to traditional lending of a library book, library devices 110₁₋ₙ may be loaned out including content. In another embodiment, library devices 110₁₋ₙ may be employed by users only on the premises of the library. In that fashion, the devices may be configured to present content only while on the premises and with valid authentication.

According to another embodiment, library server 105 may be configured to receive content from a server, such as content server 120, in order to receive new content or provide content not stored by library server 105. Library server 105 may additionally be configured to manage roll outs or distribution of content, such as new publications. In one embodiment, library server 105 may manage availability of content based on one or more restrictions associated with content. By way of example, a newly released electronic book may be associated with a restriction to only allow the library server to release the data of the electronic book to five devices. As such, library server 105 may limit access to the electronic book data to five devices at one time. It should be appreciated that library server may be configured to limit access of content to other numbers of devices and based on one or more other parameters. Similarly, library server 105 may restrict access to data stored by the server based on a release date.

According to another embodiment, library server 105 may be configured to provide content to one or more non-library devices, such as computing device 125 and mobile device 130. Library server 105 may be configured to communicate with one or more devices by way of communication network 115 to provide access and management to one content of the electronic library service. In one embodiment, library server 105 may provide a web portal to allow for searching, viewing, and requesting content of the electronic library service.

Communication network 115 may allow for one or more of wired and wireless communication. For example, communication network 115 may allow for network based communications including, but not limited to, LAN, WAN, WI-FI, etc. Computing device 125 and mobile device 130 of FIG. 1 may be configured to connect to library server 105 via communication network 110, which may include wired and/or wireless components.

Content server 120 may be configured to provide content to library server 105. In certain embodiments, publishers or content providers may provide content to content server 120 for distribution to one or more library servers, such as library server 105. In that fashion, content providers may contact a single server or particular server for distribution of newly published content. In certain embodiments, content server 120 may be configured to assign limits to content. For example, content server 120 may impose a restriction on the number of devices content is made available to for a particular period of time. In yet another embodiment, content server 120 may be configured to provide advertisement data to one or more devices. When access to content on the device expires, use of an electronic library application may display advertisement data received from content server 120 when the content is select on the device. Advertisement data may be based on content provided to a device, an author associated with content for a device, the subject of content downloaded to the device and one or more other characteristics of content. The electronic library service may allow for users to check-out or borrow content for additional periods in some instances. Content server 120 may additionally provide a communication point for publishers and content generators. Content server 120 may store received content, archive content and provide content to one or more library servers as requested.

Computing device 125 and mobile device 130 may relate to non-library devices or personal devices that may be configured to request and receive content from library server 105. In certain embodiments, users may employ their own personal devices to browse content and request content from an electronic library service. For example, computing device 125 may relate to a personal computing device. Mobile device 130 may relate to a personal communication device such as a mobile phone, media player, or network communication device in general. Based on authentication of the device by library server 105, the devices may request and receive content of the electronic library service.

Although system 100 is described above as having a single library server and single content server in FIG. 1, it may be appreciated that system 100 include a plurality of library servers. Similarly, the system of FIG. 1 may be employed to allow for a plurality of library servers to operate and service a plurality of devices.

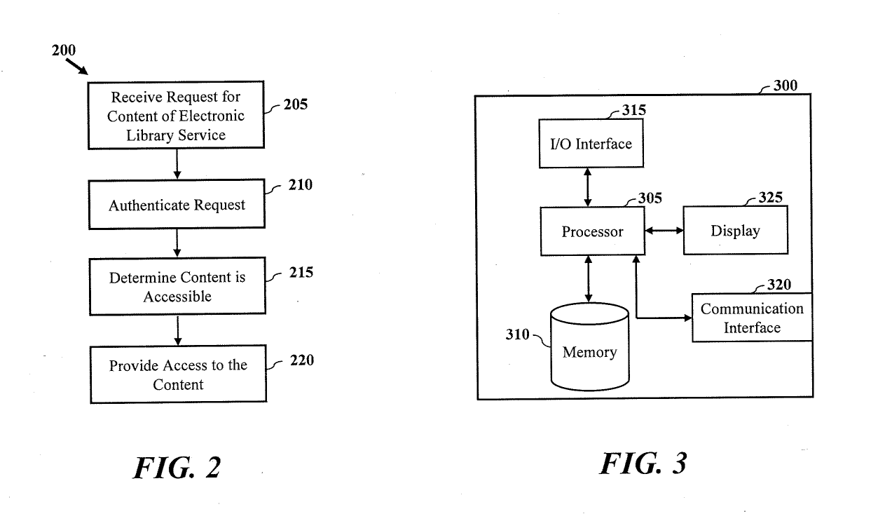

Referring now to FIG. 2, a process is depicted for providing content of an electronic library service according to one or more embodiments. Process 200 may be employed by a server (e.g., library server 105) to provide one or more devices (e.g., library devices 110₁₋ₙ, computing device 125, mobile device 130, etc.) access to content of the electronic library service. In certain embodiments, process 200 may be performed by a server of an electronic library service. Process 200 may be initiated at block 205 by receiving a request for content of an electronic library service. The request may be generated by a device (e.g., library devices 110₁₋ₙ, computing device 125, mobile device 130, etc.). The request may provide one or more of an account number for the electronic library service and an identification number of the device. Requests received at block 205 may be requests for temporary access to electronic data associated with the content, such as requests to borrow or rent content. The request may be for one or more of an electronic book, media file and application. In certain embodiments, content associated with the request may be accessible to a limited number of devices as managed by a library server.

Requests received at block 205 may be based on wired and/or wireless communication with a library server. In certain embodiments, the request received at block 205 may be generated by an electronic library service application on a device.

At block 210, the library server can authenticate the request. In one embodiment, the library server may authenticate the request based on one or more of an account number for the electronic library service and identification number of a device. The account number for the electronic library service may relate to a user account number for a particular library associated with the electronic library server. For example, each user may be provided with a unique library account number associated with one or more of an electronic account, digital certificate, electronic key, and electronic code in general. Authentication of a device may include verification of the device and rights/restrictions associated with the account identification number. In another embodiment, authentication may include identifying the device as a local device configured to receive content for a predetermined period of time from the server.

Based on valid authentication of the request at block 210, the library server may determine if content is free of one or more restriction limitations at block 215. In certain embodiments, the library server may restrict content for release to a particular number of devices. On one embodiment, content may be limited to an exemplary number of between three to ten devices. Restrictions on content may be based on the number of licenses purchased of content from a publisher or source of content. Restrictions may similarly be imposed based on a time period. For example, the electronic library service may restrict the access of content in order to delay the release of content. Some content may not be restricted and may be provided to devices without a restriction.

At block 220, access to the content may be provided based on determination associated with the one or more restriction limitations, wherein the content of the electronic library is made accessible to a device associated with the account number for a limited period of time. Library server may content that may be accessed by a device. The library server may provide temporary access which limits one or more of the number of copies in circulation, the time period for access, the number of times access and/or the number of electronic content titles assigned. The library server may additionally terminate access to the content by the server.

Although process 200 is described as being performed by a library server, it should be appreciated that the process may be performed by an electronic library application stored by the library server. According to another embodiment, process 200 may be employed to allow for renting content on a large scale. For example, the electronic library service as discussed herein may be applied to renting textbooks for educational and/or training purposes (e.g., University level, secondary school, Educational institutions in general). The electronic library service may allow devices to access textbooks or educational information for predetermined periods of time, such as based on a semester or the period of a course. The electronic library service may advantageously allow for a plurality of electronic texts to be provided on a single device. In addition to providing access to the content from a single device, users may benefit from the weight savings of providing content on a device.

Referring now to FIG. 3, a simplified block diagram is depicted of a device according to one or more embodiments. According to one embodiment, an electronic library service may be provided to allow users to use or borrow electronic devices (e.g., library devices 110₁₋ₙ). In one embodiment, device 300 may relate to a library device. Device 300 may be configured to interoperate with a library server (e.g., library server 105). In certain embodiments, library device 300 may be configured to allow a user to search for, request, view, listen and as an interface for content of the electronic library service. In certain embodiments, device 300 may be configured to operate only on the premises of a library. In other embodiments, device 300 may be configured to operate outside of a library location. Device 300 may relate to one or more of tablet, personal communication device, media player, reader device and mobile electronic device in general.

In certain embodiments, device 300 may relate to the computing device of FIG. 1. Device 300 may be configured to provide an application for an electronic library service to interface with one or more library servers. In another embodiment, device 300 may be configured to access a single library server. In other embodiments, device 300 of FIG. 3 may relate to a mobile device (e.g., mobile device 130). Users of device 300 may access a library server (e.g., library server 105) based on network communication to request and receive content associated with an electronic library service.

As depicted in FIG. 3, device 300 includes processor 305, memory 310, input/output (I/O) interface 315, communication interface 320, and display 325. Elements of device 300 may be configured to communicate and interoperate with processor 305 by a communication bus. Processor 305 may be configured to control operation of device 300 based on one or more computer executable instructions stored in memory 310. In one embodiment, processor 305 may be configured to control output of audio and video data, and run one or more applications based content of an electronic library service. Memory 310 may relate to one of RAM and ROM memories and may be configured to store one or more files, and computer executable instructions for operation of device 300. Although depicted as a single memory unit, memory 310 may relate to one or more of internal device memory and removable memory. Memory 310 may store one or more audio and video files.

Input output (I/O) interface 315 may be configured to output data and/or commands to one or more output devices. According to one embodiment, I/O interface 315 may be configured to receive one or more user commands. I/O interface 315 may include one or more buttons to control operation of device 300 including controlling selection of content for display and controlling operation of device 300. Input buttons of I/O interface 315 may include one or more buttons for user input, such as a such as a numerical keypad, volume control, menu controls, pointing device, track ball, mode selection buttons, and playback functionality (e.g., play, stop, pause, forward, reverse, slow motion, etc). Input buttons of I/O interface 315 may include hard and soft buttons, wherein functionality of the soft buttons may be based on one or more applications running on device 300.

Communication interface 320 may include one or more elements to allow for communication of device 300 by wired or wireless communication. Communication interface 320 may include one or more ports for receiving data, including ports for removable memory. Communication interface 320 may be configured to allow for network based communications including but not limited to LAN, WAN, Wi-Fi, etc.

In certain embodiments, device 300 may include display 325 to display image data, such as electronic book data, video data, and graphics data. Display 325 may be configured to present one or more applications executed by processor 305.

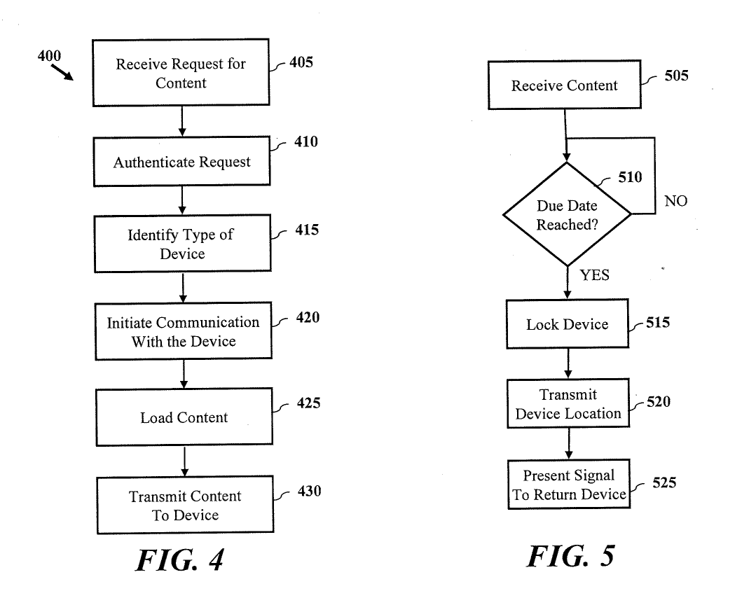

Referring now to FIG. 4, a process is depicted for interfacing with a device by a library server. According to one or more embodiments, an electronic library service may allow devices to request content of the electronic library service from a library server. Access to content may be limited by the library server based on one or more of a content restriction, authentication of the device, authentication of an account number with the electronic library, and access history of the device or account number associated with the electronic library.

Process 400 may be initiated by a library server (e.g., library server 105) receiving a request for content at block 405. The request may be generated by a library device (e.g., library device 110₁₋ₙ) or a non-library device, such as a computing device (e.g., computing device 125) or mobile device (e.g., mobile device 130) configured to communicate with the library server. The request received at block 405 may identify one or more of the requested content, a user account number, and an identification of a device. Process 400 may continue with authenticating the request at block 410. Authentication may be based on one or more of the requested content, a user account number, and identification of a device. When the device is authenticated, the library server may then identify the type of device at block 415. Identification of the type of device may be required to initiate communication with the device at block 420. At block 420, the library may initiate communication with the device associated with the request. The library server may then load content associated with the request at block 425. Loading content at block 425 may include configuring content based on a due date. In another embodiment, loading content at block 425 may include loading advertising data to be transmitted with the content. In certain embodiments, loading content at block 425 may include requesting content data from a content server (e.g., content server 120).

Once content is loaded at block 425, the library server may transmit content to the authenticated requesting device at block 430. Content may be transmitted by wired or wireless communication and may be transmitted via a communication network (e.g., communication network 115). Content may be provided to a device with one or more restrictions, such as access for a predetermined period of time. In certain embodiments, devices may require a particular application for presenting received content of the electronic library service. For example, content may be transmitted in an encoded format to only operate with a particular application for a particular period of time. At the expiration of the access period, the device application may be configured to display advertisements or block display of the content until access is granted by the library server.

Referring now to FIG. 5, a process is depicted for operation of an electronic library service application on a device. In certain embodiments, it may be desirable for a device to limit the access to content of the electronic library service. In one embodiment, electronic library service content may only be accessed and presented by an application authorized by the electronic library service. The application may provide one or more controls. Process 500 depicts management of received content according to one or more embodiments. Process 500 may be initiated by a device receiving content at block 505. The electronic library service application may check whether a due date has been reached for the received content upon each request by a user of the device for the content at block 510. When a due date has not been reached (e.g., “NO” path out of decision block 510), the application may allow a user to utilize the received content. When the due date has been reached (e.g., “YES” path out of decision block 510), the application can lock the device at block 515. Locking the device may prevent the user from utilizing the device other than viewing advertisement data in certain embodiments. In other embodiments, the application may lock the device to restrict the device from operating. The application may then transmit the location of the device to a library server at block 520. Transmitting at block 520 may be automatically performed by the application. The device may then receive a communication or signal to initiate display of a message to return that device at block 525.

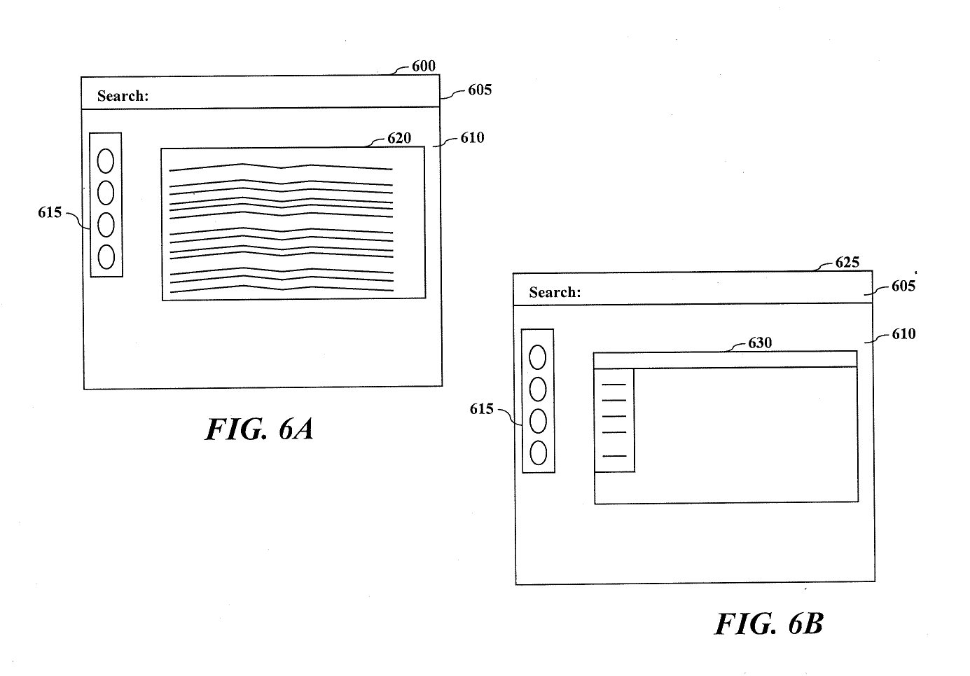

Referring now to FIGS. 6A-6B, graphical representations are depicted an electronic library service application according to one or more embodiments. FIG. 6A depicts a display window of a device, such as a library device (e.g., library device 110₁₋ₙ) or a computing device (e.g., computing device 125) configured to communicate with a library server. Display window 600 includes a search bar 605 to allow for content to be searched and retrieved. Display window 600 includes a presentation pane 610 including display of one or more navigation buttons 615 and content 620 associated with an electronic book. It may be appreciated that display window 600 may be configured to display graphic elements for a plurality of content titles of the electronic library service.

In certain embodiments, display window 600 may display advertisement data when a device is locked by a library server. In other embodiments, display of advertisement data may be associated with presentation of content. For example, based on access of content by a device and user selection for presentation, the device may present an initial display or playback of advertisement content in clouding audio, video and/or graphical data. Advertisement data may be based content provided to the device, an author of content, subject of the content, etc. In that fashion, advertisements may be targeted to one or more users.

According to another embodiment, applications may be provided by the electronic library service. Display window 625 of FIG. 6B depicts a graphical representation of an application. By way of example, the electronic library application may allow for users to temporarily utilize an application received from a library server. Accordingly, display window 625 may include a graphical display of application 630 associated with an application received from a library server.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for providing an electronic library service, the method comprising the acts of:
receiving, by a server, a request for content of the electronic library service, the request identifying an account number for the electronic library service and identification number of a device;
authenticating the request, by the server, based on an account number for the electronic library service and identification number of a device;
determining, by the server, that content associated with the request is available for access by the device based on one or more restriction limitations; and
providing access to the content based on said determining associated with the one or more restriction limitations, wherein the content of the electronic library is accessible to a device associated with the account number for a limited period of time.

2. The method of claim 1, wherein the request for content relates to an electronic request for access to electronic content of an electronic library service for a pre-determined period of time.

3. The method of claim 1, wherein the content is one or more of an electronic book, media file, gaming application, publication, periodical, and application.

4. The method of claim 1, wherein the content is accessible to a limited number of devices based on the one or more restriction limitations.

5. The method of claim 1, wherein authenticating includes authenticating the device associated with generating the request and rights for the electronic library service associated with the account identification number.

6. The method of claim 1, wherein authenticating includes identifying the device as a local device configured to receive content from the server.

7. The method of claim 1, wherein the one or more restrictions limit the number of profiles that can access the content.

8. The method of claim 1, wherein the one or more restrictions limit the time period that a user can access content.

9. The method of claim 1, wherein temporary access limits one or more of the number of electronic copies provided, the time period for access, the number of times accessed and the number of electronic content titles assigned to a device.

10. The method of claim 1, wherein providing access to the content limits content that may be accessed by the device.

11. The method of claim 1, further comprising terminating access to the content by the server.

12. A system comprising:
a plurality of devices; and
a library server, the library server configured to:
receive a request for content of an electronic library service, the request identifying an account number for the electronic library service and identification number of a device;
authenticate the request based on an account number for the electronic library service and identification number of a device;
determine that content associated with the request is available for access by the device based on one or more restriction limitations; and
provide access to the content based on determining access availability associated with the one or more restriction limitations, wherein the content of the electronic library is accessible to a device associated with the account number for a limited period of time.

13. The system of claim 12, wherein the request for content relates to an electronic request for access to electronic content of an electronic library service for a pre-determined period of time.

14. The system of claim 12, wherein the content is one or more of an electronic book, media file, gaming application, publication, periodical, and application.

15. The system of claim 12, wherein the content is accessible to a limited number of devices based on the one or more restriction limitations.

16. The system of claim 12, wherein authenticating includes authenticating the device associated with generating the request and rights for the electronic library service associated with the account identification number.

17. The system of claim 12, wherein authenticating includes identifying the device as a local device configured to receive content from the server.

18. The system of claim 12, wherein the one or more restrictions limit the number of profiles that can access the content.

19. The system of claim 12, wherein the one or more restrictions limit the time period that a user can access content.

20. The system of claim 12, wherein temporary access limits one or more of the number of electronic copies in circulation, the time period for access, the number of times accessed and the number of electronic content titles assigned to a device.

21. The system of claim 12, wherein providing access to the content limits content that may be accessed by the device.

22. The system of claim 12, further comprising terminating access to the content by the server.

23. A computer program product stored on a non-transitory computer readable medium including computer executable code for launching an application on a device, the computer program product comprising:
computer readable code to receive a request for content of the electronic library service, the request identifying an account number for the electronic library service and identification number of a device;
computer readable code to authenticate the request based on an account number for the electronic library service and identification number of a device;
computer readable code to determine that content associated with the request is available for access by the device based on one or more restriction limitations; and
computer readable code to provide access to the content based on computer readable code determining access availability with the one or more restriction limitations, wherein the content of the electronic library is accessible to a device associated with the account number for a limited period of time.

24. The method of claim 1, wherein the providing access to the content includes providing access to the content stored on the server that receives the request.

25. The system of claim 12, wherein the library server is configured to provide access to the content stored on the library server.

26. The computer program product of claim 23, wherein the computer readable code is adapted to provide access to content stored on the non-transitory computer readable medium that stores the computer program product.
